(19) United States
(12) Patent Application Publication
(10) Pub. No.: US 2015/0121027 A1
(43) Pub. Date: Apr. 30, 2015

(54) ELECTRONIC APPARATUS AND METHOD

(71) Applicant: Kabushiki Kaisha Toshiba, Tokyo (JP)

(72) Inventors: Ryuiti Koike, Kawasaki (JP); Jun Kanai, Tokyo (JP); Hiroshi Isozaki, Kawasaki (JP); Yuki Kanbe, Tokyo (JP)

(21) Appl. No.: 14/473,830

(22) Filed: Aug. 29, 2014

(30) Foreign Application Priority Data
Oct. 31, 2013 (JP) 2013-226509

(51) Int. Cl. G06F 12/14; G06F 9/54

(52) U.S. Cl. CPC G06F 12/1416; G06F 9/544
USPC 711/163

(57) ABSTRACT

According to one embodiment, an apparatus includes a receiver, a requesting controller, a substitution operation controller, a reflection controller, and an access controller. The receiver receives protection area information transmitted from a first application. The protection area information describes a protection area within storage. The requesting controller requests a second application to register first data based on the protection area information in a data file within a nonvolatile memory device. The substitution operation controller attempts to register the first data in the data file. The reflection controller reflects the protection area information in a kernel setting. The access controller controls access to data within the storage based on the kernel setting.

### CROSS-REFERENCE TO RELATED APPLICATIONS

This application is based upon and claims the benefit of priority from Japanese Patent Application No. 2013-226509, filed Oct. 31, 2013, the entire contents of which are incorporated herein by reference.

### FIELD

Embodiments described herein relate generally to an electronic apparatus and a method.

### BACKGROUND

In the file system of a conventional secure operating system, it is possible to define an object which cannot be accessed even by an application having administrative privileges by mandatory access control using a kernel layer. Therefore, this control is activated for a file to be strongly protected within a terminal in particular. For example, the control is applied to a key for DRM processing, or customer information which should not be leaked. This control prevents important information from being leaked even if a terminal is cracked and administrative privileges are stolen.

Each general application can activate its own protection area by directly notifying a special kernel interface within a volatile memory of a limitation policy.

The conventional secure operating system is operated by pouring a policy setting file which is prepared on a file system in advance into a kernel in order to activate access control. The policy setting file is generally poured in a single direction into the kernel side. A policy which is dynamically set for the kernel on a memory by a userland application (for example, via Process File System [procfs]) is not reflected on the policy setting file side on the file system. If the operation continues at this state, and the operating system is restarted or forcibly shut down, the policy which is individually set by the userland application is dealt with as nonexistent. Thus, a security problem is caused.

For the above reasons, the registration of a policy described in a policy setting file in a file within a nonvolatile memory device is desired. However, if a process of registering a policy described in a policy setting file in a file within a nonvolatile memory device is implemented in a kernel, the implementation cost is high.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of appearance of a computer of an embodiment.

FIG. 2 is a block diagram showing an example of a system structure of the computer of the embodiment.

FIG. 3 is a block diagram showing an example of structures of an operating system, a management application and a general application.

FIG. 4 is a flowchart for explaining procedures to add a policy to a policy database.

FIG. 5 is a flowchart for explaining the procedures to add the policy to the policy database in more detail.

FIG. 6 is a flowchart showing procedures of a process of uninstalling a general application.

FIG. 7 shows a structure of the policy database.

### DETAILED DESCRIPTION

Various embodiments will be described hereinafter with reference to the accompanying drawings.

In general, according to one embodiment, an electronic apparatus includes a receiver a first requesting controller, a substitution operation controller, a reflection controller, and an access controller. The receiver is configured to operate within kernel, and to receive protection area information transmitted from a first application configured to run on the kernel. The protection area information describes a protection area within storage. The first requesting controller is configured to run within the kernel, and to request a second application configured to run on the kernel to register first data based on the protection area information in a data file within a nonvolatile memory device. The substitution operation controller is configured to run within the second application, and to attempt to register the first data in the data file. The reflection controller is configured to run within the kernel, and to reflect the protection area information in a kernel setting. The access controller is configured to run within the kernel, and to control access to data within the storage based on the kernel setting.

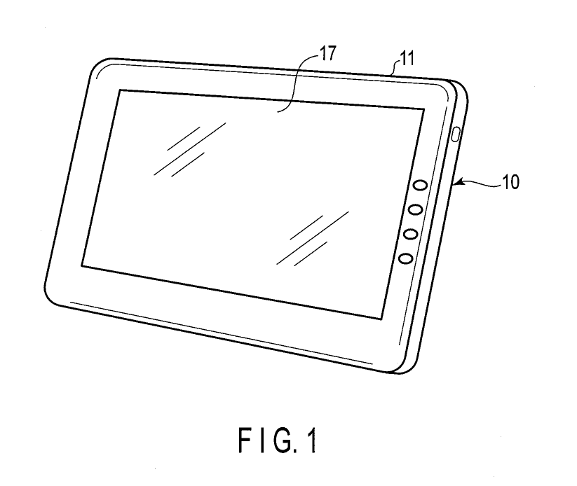

Firstly, a structure of an electronic apparatus of an embodiment is explained with reference to FIG. 1. The electronic apparatus can be realized as a portable device such as a tablet computer, a laptop or notebook computer, or a PDA. Hereinafter, this specification assumes that this route search apparatus is implemented as a tablet computer 10 (hereinafter, referred to as the computer 10).

FIG. 1 shows the appearance of the computer 10. The computer 10 is composed of a computer main body 11 and a touchscreen display 17. The computer main body 11 comprises a housing having a thin box-shape. The touchscreen display 17 is provided on the front surface of the computer main body 11. The touchscreen display 17 comprises a flat panel display (for example, a liquid crystal display device [LCD]) and a touchpanel. The touchpanel is provided in order to cover the screen of the LCD. The touchpanel is configured to detect a position of a touch on the touchscreen display 17 by a finger of a user or a stylus.

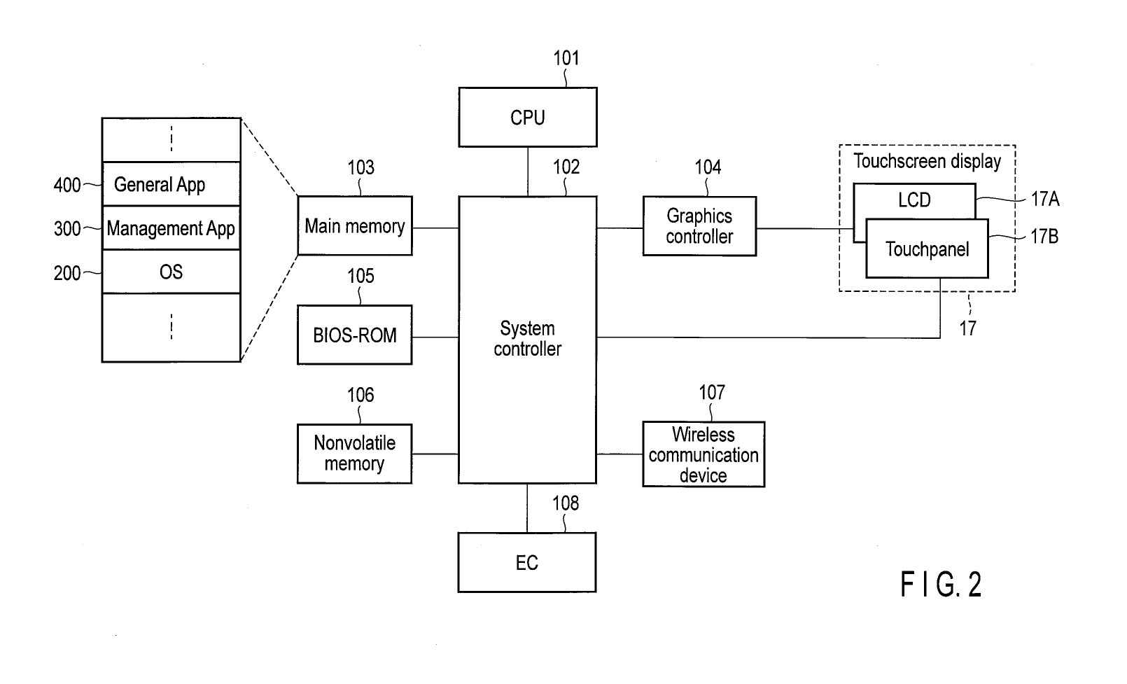

FIG. 2 is a block diagram showing a system structure of the computer 10.

As illustrated in FIG. 2, the computer 10 comprises the touchscreen display 17, a CPU 101, a system controller 102, a main memory 103, a graphics controller 104, a BIOS-ROM 105, a nonvolatile memory 106, a wireless communication device 107 and an embedded controller (EC) 108, etc.

The CPU 101 is a processor configured to control operations of various modules within the computer 10. The CPU 101 executes various types of software loaded from the nonvolatile memory 106 which is a storage device into the main memory 103 which is a volatile memory. The software includes an operating system (OS) 200 and various application programs. The application programs include a management application (management app) 300 and a general application (general app) 400. A system privilege is assigned to the management application 300. A system privilege is not assigned to the general application 400. The operating system 200 is a secure operating system.

The CPU 101 executes a basic input/output system (BIOS) stored in the BIOS-ROM 105. The BIOS is a program for hardware control.

The system controller 102 is a device configured to connect the local bus of the CPU 101 and various components. A memory controller configured to control the access of the main memory 103 is embedded in the system controller 102. Further, the system controller 102 is configured to communicate with the graphics controller 104 through a serial bus conforming to the PCI EXPRESS standard, etc.

The graphics controller 104 is a display controller configured to control an LCD 17A used as a display monitor of the computer 10. A display signal generated by the graphics controller 104 is sent to the LCD 17A. The LCD 17A displays a screen image based on the display signal. A touchpanel 17B is provided on the LCD 17A. The touchpanel 17B is a capacitive pointing device for inputting data on the screen of the LCD 17A. A contact position of a finger on the screen, and movement of the contact position, etc., are detected by the touchpanel 17B.

The wireless communication device 107 is a device configured to execute wireless communication via wireless LAN or 3G mobile communication, etc. The EC 108 is a single-chip microcomputer comprising an embedded controller for power management. The EC 108 is configured to turn the computer 10 on or off depending on the operation of a power button by a user.

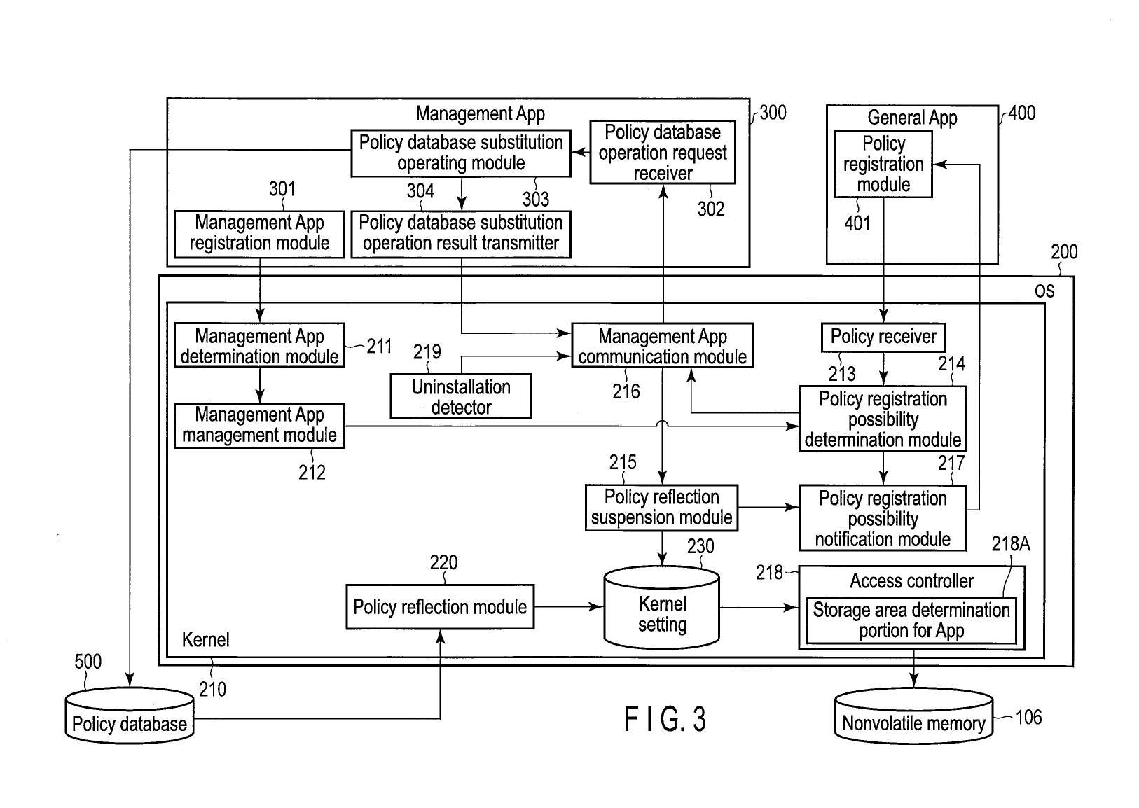

FIG. 3 is a block diagram showing structures of the operating system 200, the management application 300 and the general application 400.

The operating system 200 includes a kernel 210. The kernel 210 is a program connecting application software and hardware of the computer 10.

The management application 300 and the general application 400, etc., run on the operating system 20.

The kernel 210 comprises a management application determination module (management app determination module) 211, a management application management module (management app management module) 212, a policy receiver 213, a policy registration possibility determination module 214, a policy reflection suspension module 215, a management application communication module (management app communication module) 216, a policy registration possibility notification module 217, an access controller 218, an uninstallation detector 219 and a policy reflection module 220, etc. The management application determination module 211, the management application management module 212, the policy receiver 213, the policy registration possibility determination module 214, the policy reflection suspension module 215, the management application communication module 216, the policy registration possibility notification module 217, the access controller 218, the uninstallation detector 219 and the policy reflection module 220 run within the kernel 210.

The management application (management app) 300 comprises a management application registration module (management app registration module) 301, a policy database operation request receiver (policy database operation request receiver) 302, a policy database substitution operation module (policy database substitution operation module) 303 and a policy database substitution operation result transmitter (policy database substitution operation result transmitter) 304, etc. The management application registration module 301, the policy database operation request receiver 302, the policy database substitution operation module 303 and the policy database substitution operation result transmitter 304 run within the management application 300.

The general application (general app) 400 comprises a policy registration module 401, etc. The policy registration module 401 runs within the general application 400.

The management application registration module 301 of the management application 300 transmits a management application registration request when the management application is activated in order to teach the kernel 210 that the management application itself is a rights management application.

The management application determination module 211 within the kernel 210 obtains information unique to the application which transmitted the management application registration request, such as a file name, a hash value and a package name of the application. Based on the information obtained by an application unique information obtainment module and the information registered in advance, the management application management module 212 within the kernel 210 determines whether or not the application which transmitted the management application registration request is a rights management application configured to change the contents of a policy database (file) 500 described later. If the application which transmitted the request is determined as being a rights management application, the management application management module 212 stores application information indicating the application which transmitted the management application registration request inside in order to register the application as a rights management application. After the registration, the management application management module 212 informs the management application registration module 301 of the management application 300 that the application is registered as a rights management application. If the application which transmitted the request is determined as being an inappropriate management application, the management application management module 212 informs the management application registration module 301 of the management application that the application is not registered as a rights management application.

By writing a policy setting file (protection area information) in which a policy indicating an area defined as a protection area is described in the kernel 210, the policy registration module 401 of the general application 400 requests a kernel setting within the kernel 210 to register the policy. The policy receiver 213 within the kernel 210 receives the policy setting file transmitted from the policy registration module 401. The policy registration possibility determination module 214 within the kernel 210 determines whether or not the scope of the policy shown by the policy setting file received by the policy receiver 213 is appropriate. If the policy registration possibility determination module 214 determines that the scope of the policy is not appropriate, the policy registration possibility notification module 217 notifies the policy registration module 401 that the policy cannot be stored.

If the policy registration possibility determination module 214 determines that the scope of the policy is within an appropriate scope, the policy registration possibility determination module 214 passes the policy setting file and an application identifier for identifying the application which transmitted the policy setting file to the policy reflection suspension module 215. The policy registration possibility determination module 214 transmits the policy setting file to the management application by means of the management application communication module 216, and requests the management application to register the policy in the database 500.

The policy database operation request receiver 302 of the management application receives the policy setting file transmitted from the management application communication module 216 and the application identifier. The policy database substitution operation module 303 attempts to register data (first data) including the application identifier and the policy based on the policy setting file in the policy database 500 as a data file. The policy database substitution operation result transmitter 304 notifies the kernel 210 of whether or not the registration of the policy is successful.

The policy database 500 is stored in a nonvolatile memory device such as a hard disk drive (HDD) and a solid state drive (SSD) within a server configured to communicate using the nonvolatile memory 106 or the wireless communication device 107, etc. If the policy is successfully registered in the policy database 500, the policy reflection suspension module 215 registers the policy based on the policy setting file in a kernel setting 230.

If there is an access request to the nonvolatile memory 106, the access controller 218 controls the access to the nonvolatile memory 106 based on the kernel setting 230.

Specifically, a storage area determination module for applications (storage area determination module for apps) 218A of the access controller 218 determines whether or not the access to the nonvolatile memory 106 is in the protection area (area for applications) based on the policy reflected within the kernel setting 220. If the access is determined as being in the protection area (area for applications), the access controller 218 controls the access to the nonvolatile memory 106 based on the setting within the kernel 210.

At the time of restart or activation after compulsory shutdown, the policy reflection module 220 reflects the policy registered in the policy database 500 in the kernel setting 230.

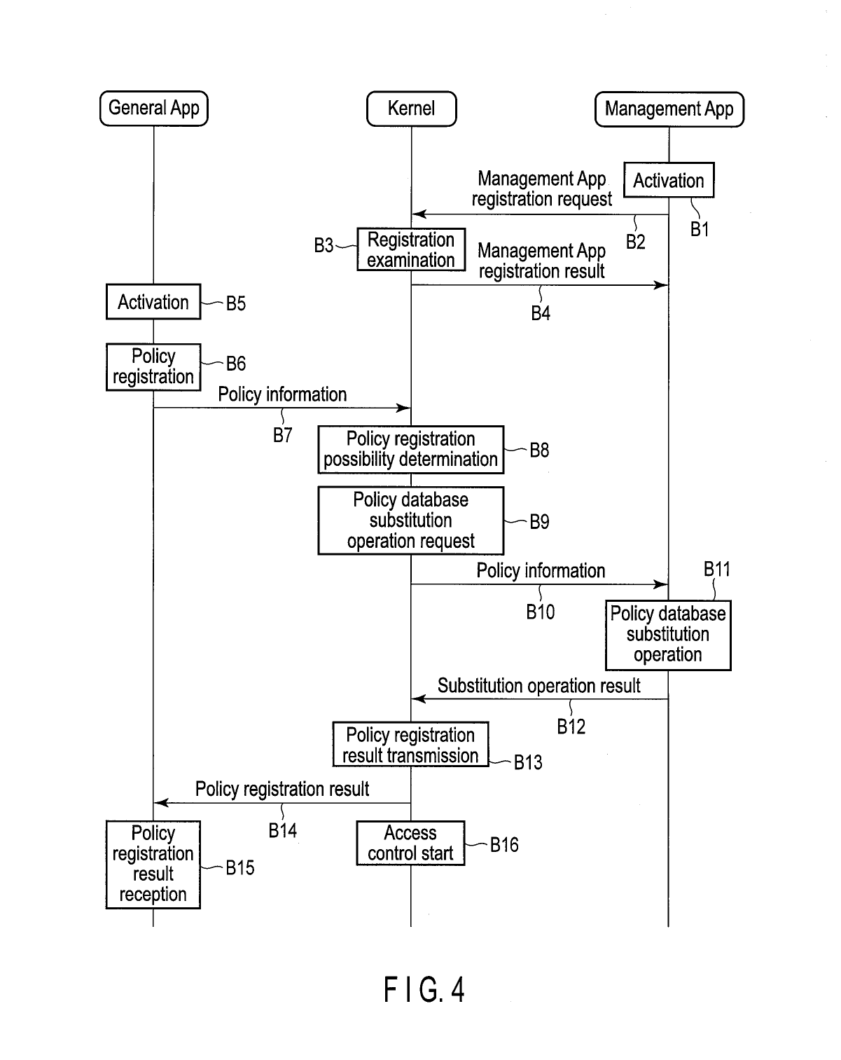

FIG. 4 is a flowchart for explaining procedures to add a policy to the policy database 500.

When the management application 300 is activated (block B1), in order to inform the kernel 210 that the management application 300 itself is a rights management application, the management application 300 sends a management application registration request (management app registration request) to the kernel 210 (block B2). After reception of the management application registration request, the management application determination module 211 of the kernel 210 examines whether or not the application which transmitted the management application registration request is a rights management application (block B3). If the application which transmitted the management application registration request is confirmed as a rights management application through the examination, the management application management module 212 registers the application as a rights management application. The management application registration module 301 sends a registration result back to the management application module (block B4). The processes of blocks B1 to B4 are conducted only once at the time of activation of the computer 10.

After that, the general application 400 is activated at an arbitrary time (block B5). When the general application wants to protect a file stored by the general application itself in the nonvolatile memory 106, the policy registration module 401 transmits a policy setting file and an application identifier to the kernel 210 (blocks B6 and B7). The policy registration possibility determination module 214 of the kernel 210 which received the policy setting file determines whether or not the description of the policy to be set is within the scope of the authority which can be registered as a general application (block B8). If the description of the policy is determined as being within the scope of the authority which can be registered, the policy registration possibility determination module 214 sends a policy database substitution operation request as well as the policy setting file and the application identifier to the management application module by means of the management application communication module 216 (blocks B9 and B10). Through the policy database substitution operation request, application of a nonvolatile processing to the policy is requested to the management application 300. In other words, storage in the policy database 500 is requested. Actual access control is not begun until the nonvolatile processing is successfully applied to the policy. The policy database operation request receiver 302 receives the request to register the policy in the policy database 500 from the management application. The policy database substitution operation module 303 performs a policy database substitution operation and attempts to store the policy and the application identifier (block B1). The policy database substitution operation result transmitter 304 of the management application 300 sends information indicating whether or not the storage is successful back to the kernel 210 as a substitution operation result (block B12). The policy registration possibility notification module 217 of the kernel 210 which received the substitution operation result sends the result of the policy registration back to the general application 400 (blocks B13 and B14). The general application 400 which received the policy registration result can recognize that the policy to be registered was accepted by the kernel 210 and a nonvolatile processing was applied to the policy (block B15). The access controller 218 of the kernel 210 begins access control in accordance with the policy since a series of processes for registering the policy has been completed (block B16).

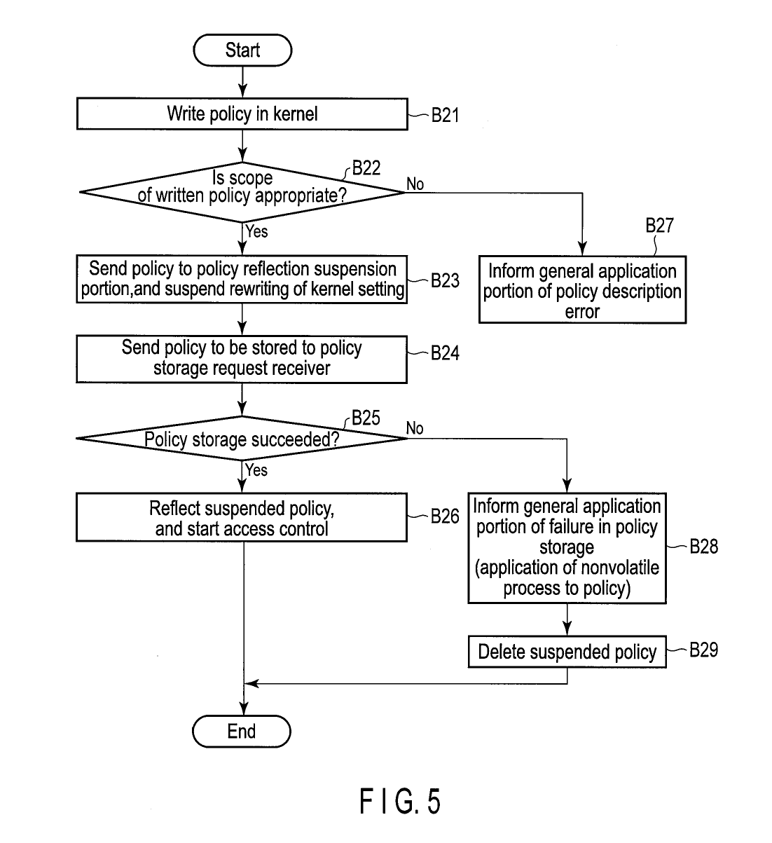

FIG. 5 is a flowchart for explaining the procedures to add the policy to the policy database 500 in more detail.

The policy registration module 401 transmits a policy setting file to the kernel 210 (block B21). The policy receiver 213 receives the policy setting file. The policy registration possibility determination module 214 determines whether or not the description of the received policy information is within the scope of the authority which can be registered as a general application (block B22).

If the description of the policy setting file is determined as being outside of the authority which can be registered (No in block B22), the policy registration possibility notification module 217 informs the policy registration module 401 of the general application 400 of the determination result as a description error of the policy (block B27). If the description of the policy setting file is determined as being within the scope of the authority which can be registered (Yes in block B22), the policy registration possibility determination module 214 sends the policy setting file to the policy reflection suspension module 215, and suspends rewriting of the kernel setting 230 based on the policy setting file (block B23). The policy registration possibility determination module 214 transmits the policy setting file and the application identifier to the policy database operation request receiver 302 of the management application 300 by means of the management application communication module 216 (block B24). The policy database substitution operation module attempts to register data based on the policy setting file and the application identifier in the policy database 500. The policy database substitution operation result transmitter 304 sends the registration result indicating whether or not the registration is successful to the kernel 210. The policy reflection suspension module 215 determines whether or not the policy is successfully registered based on the registration result (block B25). If the registration of the policy is determined as being successful (Yes in block B25), the policy reflection suspension module 215 reflects the policy based on the suspended policy setting file in the kernel setting 230. The access controller 218 controls access based on the policy within the kernel setting 230.

If the registration of the policy is determined as being unsuccessful (No in block B25), the policy registration possibility notification module 217 notifies the policy registration module 401 of the general application 400 that the registration of the policy failed (block B28). The policy reflection suspension module 215 deletes the suspended policy setting file (block B29).

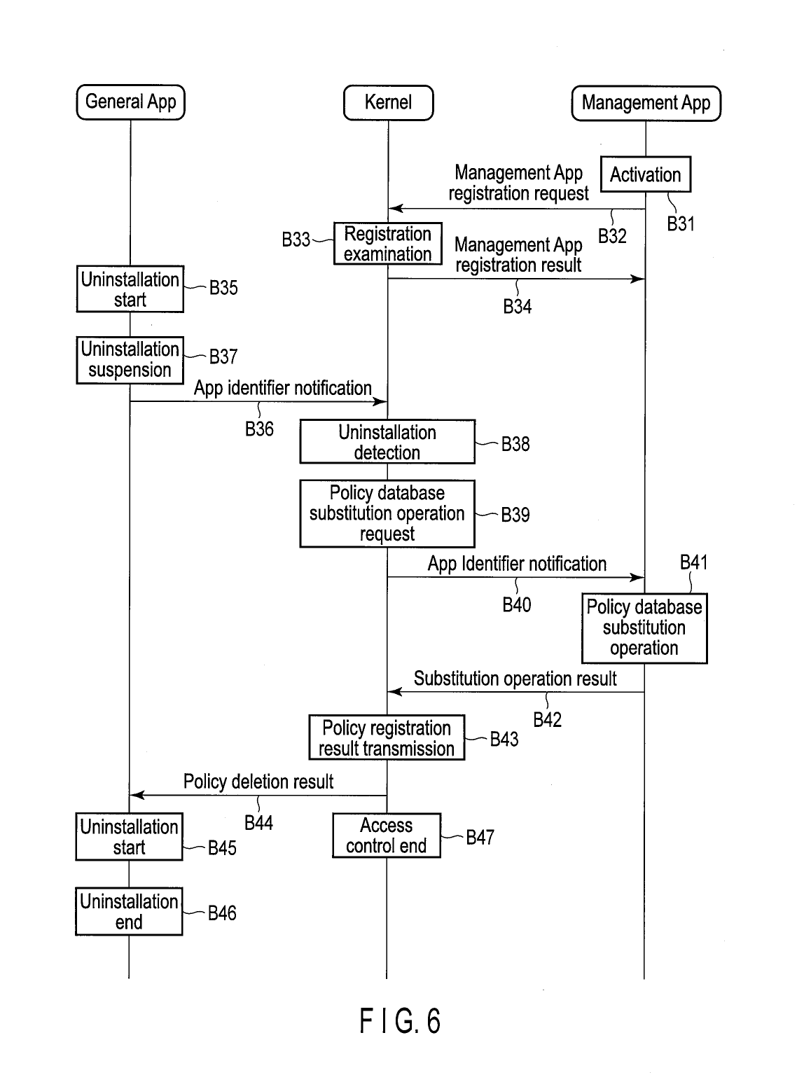

FIG. 6 is a flowchart showing procedures of a process of uninstalling a general application.

When the management application 300 is activated (block B31), in order to inform the kernel 210 that the management application 300 itself is a rights management application, the management application 300 sends a management application registration request (management app registration request) to the kernel 210 (block B32). After the reception of the management application registration request, the management application determination module 211 of the kernel 210 examines whether or not the application which transmitted the management application registration request is a rights management application (block B33). After the examination confirms that the application which sent the management application registration request is a rights management application, the management application management module 212 registers the application as a rights management application. The management application registration module 301 sends the registration result back to the management application module (block B34). The processes of blocks B31 to B34 are conducted only once at the time of activating the computer 10.

The operating system 200 begins uninstallation of the general application 400 (block B35). The operating system 200 informs the kernel 210 of the application identifier of the general application 400 to be uninstalled (block B36).

The uninstallation detector 219 of the kernel 210 detects uninstallation of the general application 400 (block B38). The uninstallation detector 219 informs the management application 300 of the application identifier of the general application 400 by means of the management application communication module 216, and requests the management application 300 to delete the policy corresponding to the management application 300 from the policy database 500 (block B40). The policy database substitution operation module 303 attempts to delete the policy corresponding to the application identifier from the policy database 500 (block B41). The policy database substitution operation result transmitter 304 transmits a policy deletion result to the kernel 210 (block B42). The kernel 210 transmits the policy deletion result to the operating system 200 (block B44). If the policy deletion result indicates the success of the deletion of the policy, the operating system 200 restarts the uninstallation of the general application 400 (block B45). After that, the operating system 200 finishes the uninstallation of the general application 400 (block B46). The access controller 218 stops access control corresponding to the general application 400.

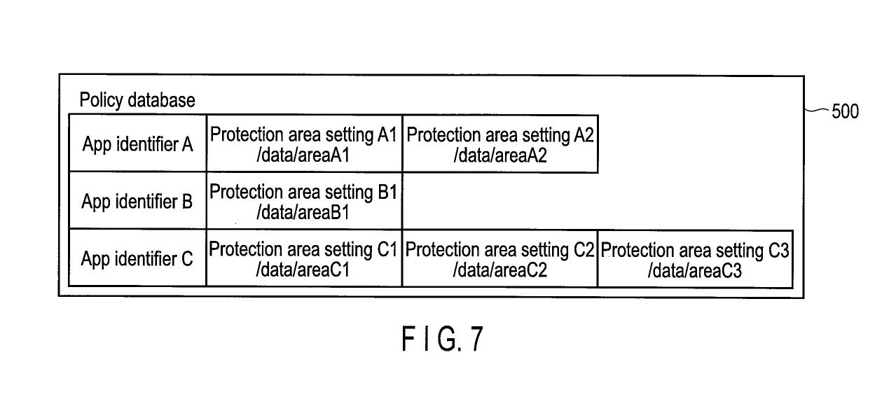

FIG. 7 shows a structure of the policy database 500.

The policy database 500 includes application identifiers, and protection area settings associated with the application identifiers. The protection area settings include paths indicating protection areas. When registration of a protection area in the policy database 500 is requested from the kernel 210, the policy database substitution operation module 303 attempts to register an application identifier and a protection area setting associated with the application identifier in the policy database 500.

When deletion of a policy as well as an application identifier is requested from the kernel 210, the policy database substitution operation module 303 attempts to delete the application identifier, and a protection area setting associated with the application identifier.

As shown in FIG. 7, the policy database 500 includes an application identifier A (app identifier A), and a protection area setting A1 and a protection area setting A2 which are associated with application identifier A. Protection area setting A1 includes /data/areaA2 as a protection area path. Protection area setting A2 includes /data/areaA2 as a protection area path. The policy database 500 includes an application identifier B (app identifier B), and a protection area setting B1 associated with application identifier B. Protection area setting B1 includes /data/areaB1 as a protection area path. The policy database 500 includes an application identifier C (app identifier C), and a protection area setting C1, a protection area setting C2 and a protection area setting C3 which are associated with application identifier C. Protection area setting C1 includes /data/areaC1 as a protection path. Protection area setting C2 includes /data/areaC2 as a protection area path. Protection area setting C3 includes /data/areaC3 as a protection area path.

By registering the policy described in the policy setting file in the policy database 500 within the nonvolatile memory device through the management application 300 which runs on the kernel, it is possible to write an update process of the policy file while support of libraries abundantly prepared on the userland side, etc., is received. Therefore, the policy setting file can be flexibly operated, and the implementation cost can be kept low.

Various processes of the embodiments described herein can be realized by a computer program. Therefore, effects which are similar to the embodiments can be easily obtained by only installing the computer program in a normal computer through a computer-readable storage medium in which the program is stored, and implementing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to operate within kernel, and to receive protection area information transmitted from a first application configured to run on the kernel, wherein the protection area information describes a protection area within storage;
a first requesting controller configured to run within the kernel, and to request a second application configured to run on the kernel to register first data based on the protection area information in a data file within a nonvolatile memory device;
a substitution operation controller configured to run within the second application, and to attempt to register the first data in the data file;
a reflection controller configured to run within the kernel, and to reflect the protection area information in a kernel setting; and
an access controller configured to run within the kernel, and to control access to data within the storage based on the kernel setting.

2. The apparatus of claim 1, further comprising a determination controller configured to run within the kernel, and to determine whether the second application is an application allowed to operate the data file.

3. The apparatus of claim 1, further comprising a notification controller configured to run within the second application, and to notify the kernel of whether the first data is registered in the data file, wherein
when the notification controller notifies the kernel that the first data is registered in the data file, the reflection controller is configured to reflect the protection area information in the kernel setting.

4. The apparatus of claim 1, further comprising:
a detector configured to run within the kernel, and to detect that the first application is uninstalled; and
a second requesting controller configured to run within the kernel, and to request the substitution operation controller to delete the first data from the data file when the detector detects that the first application is uninstalled, wherein
the substitution operation controller is configured to attempt to delete the first data from the data file in accordance with a request from the second requesting controller.

5. A method of using a protection area in storage comprising:
receiving, by a receiver configured to operate within the kernel, protection area information transmitted from a first application configured to run on kernel, wherein the protection area information describes the protection area within storage;
requesting, by a first requesting unit configured to operate within the kernel, a second application configured to run on the kernel to register first data based on the protection area information in a data file within a nonvolatile memory device;
attempting, by a substitution operation controller configured to run within the second application, to register the first data in the data file;
reflecting, by a reflection controller configured to run within the kernel, the protection area information in a kernel setting; and
controlling, by an access controller configured to operate within the kernel, access to data within the storage based on the kernel setting.

6. A computer-readable, non-transitory storage medium configured to store a computer program which is executable by a computer, the computer program controlling the computer to execute functions of:
receiving, by a receiver configured to operate within kernel, protection area information transmitted from a first application configured to run on the kernel, wherein the protection area information describes a protection area within storage;
requesting, by a first requesting unit configured to operate within the kernel, a second application configured to run on the kernel to register first data based on the protection area information in a data file within a nonvolatile memory device;
attempting, by a substitution operation controller configured to run within the second application, to register the first data in the data file;
reflecting, by a reflection controller configured to run within the kernel, the protection area information in a kernel setting; and
controlling, by an access controller configured to operate within the kernel, access to data within the storage based on the kernel setting.
